(19) United States
(12) Patent Application Publication
(10) Pub. No.: US 2019/0163795 A1
(43) Pub. Date: May 30, 2019

(54) DATA ALLOCATING SYSTEM AND DATA ALLOCATING METHOD

(71) Applicant: INSTITUTE FOR INFORMATION INDUSTRY, Taipei (TW)

(72) Inventors: Chin-Feng LAI, Kaohsiung City (TW); Ying-Hsun Lai, Tainan City (TW); Yu-Cheng Hsiao, Taipei City (TW); Chi-Cheng Chuang, Kaohsiung City (TW)

(21) Appl. No.: 15/831,359

(22) Filed: Dec. 4, 2017

(30) Foreign Application Priority Data
Nov. 27, 2017 (TW) 106141218

(51) Int. Cl. G06F 17/30; G06F 11/34

(52) U.S. Cl. CPC G06F 17/30533; G06F 17/30477; G06F 11/3476; G06F 17/30595; G06F 17/30315

(57) ABSTRACT

The data allocating system, which is applied on a relational data node and distributed data nodes, includes a memory and a processor. The processor accesses a set of instructions from the memory and executes the set of instructions. The processor includes a correlation analyzing module, a query analyzing module, a performance analyzing module, and a decision module. The correlation analyzing module generates a correlation result according to a correlation of tables stored in the relational data node. The query analyzing module generates a query result according to queries in the log reports of the relational data node. The performance analyzing module generates a performance result according to execution times of the query result being executed by each of the distributed data nodes. The decision module selects the tables to be transferred to the distributed data nodes according to the correlation result, the query result and the performance result.

### CROSS-REFERENCE TO RELATED APPLICATION

This application claims priority to Taiwan Application Serial Number 106141218, filed on Nov. 27, 2017, which is herein incorporated by reference.

### BACKGROUND

### Field of Invention

Present disclosure relates to a data allocating system and a data allocating method. More particularly, present disclosure relates to data allocating system and method applied on relational data node and distributed data nodes.

### Description of Related Art

In NoSQL data cluster, data are being stored as data blocks in a data node. Data inputs are divided into several data blocks, and these data blocks are stored in several data nodes of the data cluster. The allocations of the data blocks are managed by a name node of a master node.

However, there are still some unsolved problems when applying distributed NoSQL data cluster. For example, when the data are distributed to different data nodes, the times that each of the data nodes accesses these data are different, and it delays the entire accessing process. In another example, data conflicts may happen when data being distributed to multiple data nodes are accessed in parallel in a calculation process. Or, if any data node in the cluster is down or the network of cluster is down, some data in the cluster will be unavailable.

In these problems, the delay of the accessing process caused by different data nodes is the major problem that needs solving. Aiming to solve this problem, improvements to existing data allocating system are required.

### SUMMARY

The disclosure provides a data allocating system which is applied on a relational data node and a plurality of distributed data nodes. The data allocating system comprises a memory and a processor. The memory stores a set of instructions. The processor is electrically coupled to the memory. The processor is configured to access the set of instructions from the memory and execute the set of instructions. The processor comprises a correlation analyzing module, a query analyzing module, a performance analyzing module, and a decision module. The correlation analyzing module is configured to generate a correlation result according to a correlation of access counts of a plurality of tables being stored in the relational data node. The query analyzing module is configured to search log reports of the relational data node and generate a query result according to a plurality of queries in the log reports. The performance analyzing module is configured to test the distributed data nodes with executions of the query result respectively, and generate a performance result according to execution times of the query result being executed by each of the distributed data nodes. The decision module is configured to select at least two correlated tables from the tables as a first table set according to the correlation result and the query result, and determines the first table set to be transferred to a first distributed data node of the distributed data nodes according to the performance result.

Another aspect of present disclosure is to provide data allocating method. The data allocating method is applied on a relational data node and a plurality of distributed data nodes. The data allocating method is executed by a processor. The processor comprises a correlation analyzing module, a query analyzing module, a performance analyzing module, and a decision module. The data allocating method comprises following steps: the correlation analyzing module generates a correlation result according to a correlation of access counts of a plurality of tables being stored in the relational data node; the query analyzing module searches log reports of the relational data node and generates a query result according to a plurality of queries in the log reports; the performance analyzing module tests the distributed data nodes with executions of the query result, respectively, and generates a performance result according to execution times of the query result being executed by each of the distributed data nodes; and the decision module selects at least two correlated tables as a first table set according to the correlation result and the query result, and determines the first table set to be transferred to a first distributed data node of the distributed data nodes according to the performance result.

It is to be understood that both the foregoing general description and the following detailed description are by examples, and are intended to provide further explanation of the disclosure as claimed.

### BRIEF DESCRIPTION OF THE DRAWINGS

Present disclosure can be more fully understood by reading the following detailed description of the embodiment, with reference made to the accompanying drawings as follows:

FIG. 1 is a schematic diagram of a data allocating system illustrated according to some embodiments of the present disclosure;

FIG. 2 is a schematic diagram of a dependency structure matrix illustrated according to some embodiments of the present disclosure;

FIG. 3 is a schematic diagram of references among several data tables illustrated according to some embodiments of the present disclosure; and

FIG. 4 is a flow chart of a data allocating method illustrated according to some embodiments of present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

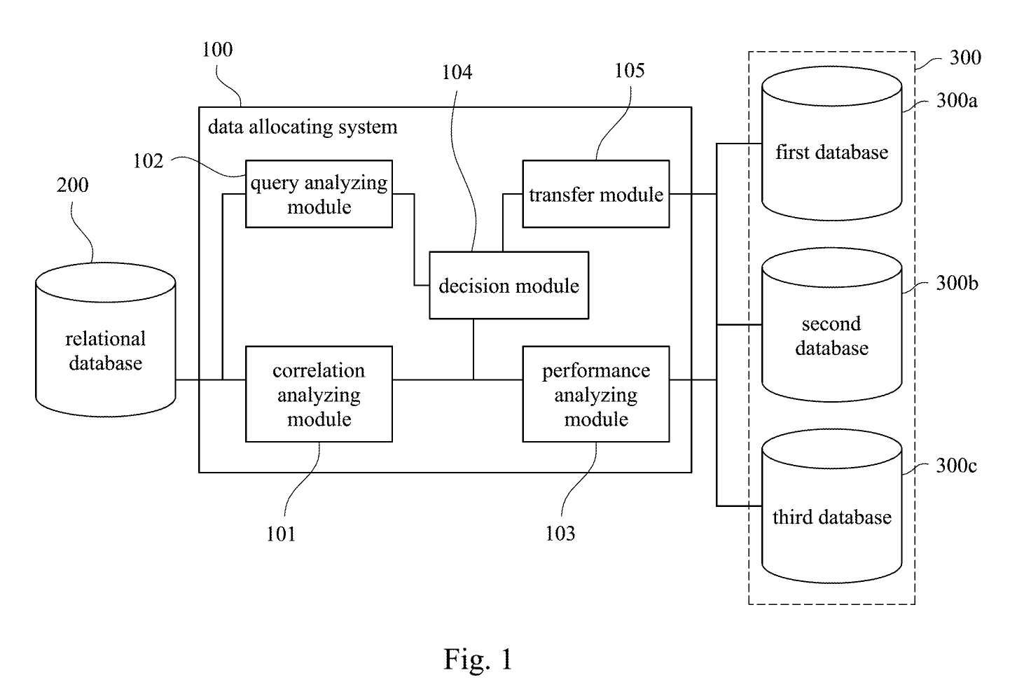

FIG. 1 is a schematic diagram of a data allocating system illustrated according to one embodiment of the present disclosure. In the embodiment, a data allocating system 100 comprises a correlation analyzing module 101, a query analyzing module 102, a performance analyzing module 103, a decision module 104 and a transfer module 105. In the embodiment, the data allocating system 100 is in communication with a relational database 200 and a distributed data cluster 300. The distributed data cluster 300 is a NoSQL data cluster comprising a first database 300a, second database 300b, and a third database 300c. In the embodiment, the data allocating system 100 is coupled between the relational database 200 and the distributed data cluster 300. The data allocating system 100 is configured to allocate a plurality of data tables stored in the relational database 200 to the first database 300a, the second database 300b and the third database 300c of the distributed data cluster 300.

In the embodiment, the correlation analyzing module 101 is configured to analyze the data tables stored in the relational database 200 for their types and the sizes of the data tables. For instance, in a data warehouse, one data table can be a fact table or a dimension table. Usually, a common data warehouse has few fact tables and many dimension tables, relatively. Fact tables are the cores of the data warehouse, configured to store history values. For example, data being stored in a fact table can be genuine values regarding selling of some merchandise. On the other hand, a dimension tables is a data table located in the star or snowflake dimension of the data warehouse, data being stored in the dimension table are to describe dimensions of the attributes. For example, if the dimension table is provided to describe dimensions of time attribute, the dimension table may store time units, such as years, seasons, months or days. It is noted, the foreign keys of several fact tables can be referenced to the primary key of a single dimension table.

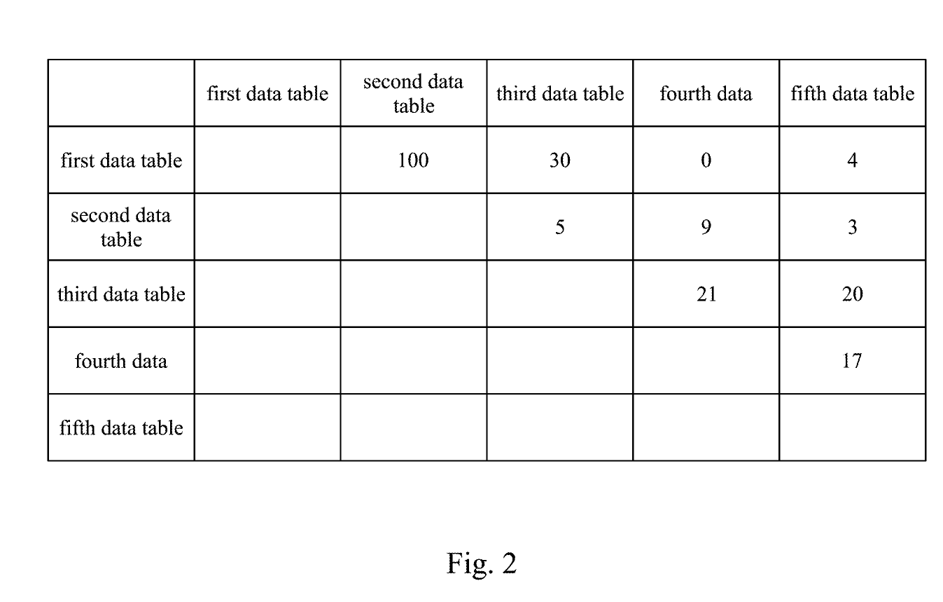

In the embodiment, the correlation analyzing module 101 is configured to analyze the data tables stored in the relational database 200 based on a dependency structure matrix (DSM). Through the analysis, the correlation analyzing module 101 can determine cross-correlations of the access counts of these data tables, and the correlation analyzing module 101 can generate a correlation result regarding the data tables according to the cross-correlations of the access counts of the data tables. For instance, in one embodiment, the relational database 200 stores the data tables comprising a first data table, a second data table, a third data table, a fourth data table, and a fifth data table. The correlation analyzing module 101 can determine the correlation result regarding the five data tables based on the dependency structure matrix shown in FIG. 2.

FIG. 2 is a schematic diagram of a dependency structure matrix illustrated according to some embodiments of the present disclosure. As shown in FIG. 2, the rows in the table diagram are ordered as the first data table, the second data table, the third data table, the fourth data table, and the fifth data table. In the same manner, the columns in the table diagram are also ordered as the first data table, the second data table, the third data table, the fourth data table, and the fifth data table. In the table diagram, the values being recited in each block intercrossed by the rows and the columns represent the data tables of the rows and the columns were accessed at the same time, and the values are indications to table correlations between these data tables. For example, the value recorded in the intercrossed block of the second column and the first row is 100, it means that the first data table and the second data table are accessed simultaneously for a hundred times. The value recorded in the intercrossed block of the fifth column and the third row is 20, it means that the third data table and the fifth data table are accessed simultaneously for twenty times. It should be understood that the table correlations between each other pair of data tables can be read on abovementioned basis and are not listed here repeatedly.

As shown in FIG. 1, in the embodiment, after the correlation analyzing module 101 determines the correlation result between each pair of the data tables in the relational database 200 according to the dependency structure matrix, the correlation analyzing module 101 can run the correlation result of the data tables with a normal distribution simulation, then the correlation analyzing module 101 can generate the final correlation result after the normal distribution simulation.

In the embodiment, the query analyzing module 102 is configured to analyze log records of the relational database 200. Based on the analysis, the query analyzing module 102 can extract multiple queries that are frequently executed by the users of the relational database 200 to access the data tables. For example, the queries can include SELECT query, SCAN query, JOIN query, INSERT query or DELETE query, etc. The query analyzing module 102 can search the log records of the relational database 200 and determine the frequently used queries according to execution frequencies of these queries. Moreover, the query analyzing module 102 can confirm the data tables that are frequently accessed by these queries in the relational database 200. In the embodiment, the query analyzing module 102 can select the queries associated with high execution frequencies and the data tables being confirmed to generate the query result.

In the embodiment, the performance analyzing module 103 is configured to generate a performance result according to several execution times, in which the execution times are the times that each data node of the distributed data cluster 300 processes the query result, respectively. In the embodiment, the performance analyzing module 103 can select some testing tables from the data tables stored in the relational database 200. It is noted, the selection of the testing tables are processed based on a predetermined percentage or a predetermined number of the data tables. For example, the performance analyzing module 103 can select 20 percent (%) of records from each data table in the relational database 200 as the testing tables. In another example, the performance analyzing module 103 can select up to 10 million records from each data table in the relational database 200 as the testing tables. In the embodiment, when the selection of the testing tables is accomplished, the performance analyzing module 103 can copy testing tables to the first database 300a, the second database 300b and the third database 300c of the distributed data cluster 300, respectively. When the testing tables are copied to the databases in the cluster, the first database 300a, the second database 300b and the third database 300c temporarily store the testing tables respectively.

In the embodiment, after the performance analyzing module 103 copies the testing tables to the first database 300a, the second database 300b and the third database 300c of the distributed data cluster 300, the performance analyzing module 103 can conduct a testing process. In the testing process, each of the first database 300a, the second database 300b and the third database 300c runs the query result on the testing tables in order to find out the execution times that these frequently used queries being applied to the testing tables in each database. Based on the testing process, the performance analyzing module 103 can generate the performance result with respect to each databases of the distributed data cluster 300. For example, the performance analyzing module 103 can apply SELECT query, SCAN query, JOIN query and INSERT query to the testing tables stored in the first database 300a, the second database 300b and the third database 300c, respectively. The performance analyzing module 103 can records the execution times that each of the the first database 300a, the second database 300b and the third database 300c accomplishes the testing process as the performance result.

In the embodiment, the decision module 104 is configured to select some data tables to be transferred from the relational database 200 to the first database 300a, the second database 300b and the third database 300c of the distributed data cluster 300. For instance, the decision module 104 can select one data table having highest access rate as a first target table according to the query result, and the decision module 104 can select another data table which is highly correlated to the first target table as a second target table according to the correlation result and the query result. The selected first and the second target tables forms a first table set. Afterwards, the decision module 104 can determine one database of the distributed data cluster 300 as a transfer target of the first table set. The database being selected as the transfer target is the database has the shortest execution time for running the query result through the first and the second target tables. In the embodiment, the first database 300a is the database has the shortest execution time, so the decision module 104 selects the first database 300a as the transfer target of the first table set. The decision module 104 then handles the first table set to the transfer module 105, and the transfer module 105 can initial a transfer process to transfer the first table set to the first database 300a of the distributed data cluster 300.

In the embodiment, the transfer module 105 is configured to determine whether a volume of the first table set is smaller than a capacity of the transfer target. For instance, as mentioned, the decision module 104 selects the first table set to be transferred to the first database 300a of the distributed data cluster 300, and the transfer module 105 will execute the transfer process under these conditions. Since the correlation analyzing module 101 of the data allocating system 100 has analyzed the sizes of each data table in the relational database 200 in a prior stage, the transfer module 105 can therefore determine whether it is available for the first database 300a to store the first table set in accordance with information of the sizes of each data table. In the embodiment, if the volume of the first table set is smaller than the capacity of the first database 300a, the transfer module 105 can transfer the first table set to the first database 300a. In the embodiment, if the volume of the first table set is larger than the capacity of the first database 300a, the transfer module 105 can determine whether the two data tables of the first table set include dimension tables. If the two data tables of the first table set include dimension tables, the transfer module 105 can start a dividing process. In the dividing process, the transfer module 105 can reserve the dimension tables in the first table set as the first priority, and the transfer module 105 can remove some fact tables from the first table set. Therefore, the volume of the first table set can be reduced by the dividing process. Afterwards, the decision module 104 can continue to transfer the divided first table set to the first database 300a.

In the embodiment, when the volume of the first table set is smaller than the capacity of the first database 300a of the distributed data cluster 300, the transfer module 105 can transfer the primary keys and the foreign keys of the first table set to the first database 300a. Then, the transfer module 105 can re-order the rest of columns in the first table set according to execution frequencies of the queries being recorded in the query result, and the transfer module 105 can transfer the re-ordered columns of the first table set to the first database 300a of the distributed data cluster 300.

In the embodiment, when the transfer module 105 accomplishes the transfer process for transferring the first table set to the first database 300a, the decision module 104 can initialize another transfer process. The transfer module 105 can select one of the data tables with the second highest access rate as a third target table and select another data table highly correlated to the third target table as a fourth target table. The third target table and the fourth target table being selected forms a second table set. Based on the performance result, the decision module 104 can select the first database 300a, the second database 300b, or the third database 300c from the distributed data cluster 300 as the transfer target of the second table set. Then, the transfer process will be handled to the transfer module 105. In the same manner, the transfer module 105 can determines whether the transfer target is available to store the second table set. If the capacity of the transfer target cannot fit the second table set, the transfer module 105 can further determine if it is possible to divide the second table set and proceed with the transfer process.

It should be noted, in one embodiment of present disclosure, the data allocating system 100 includes a processor (not shown) and a memory (not shown). In the embodiment, the processor can be the central processing unit (CPU) of a computing device, which can be programmed to interpret computer instructions, to process computer software, and to execute multiple computing procedures. In the embodiment, the memory includes primary storages and secondary storages. The processor can be associated with the memory of the data allocating system 100. The processor is configured to load instructions from the memory and to execute the instructions. It is noted, the correlation analyzing module 101, the query analyzing module 102, the performance analyzing module 103, the decision module 104, and the transfer module 105 comprised by the data allocating system 100 are blocks of the processor. When the processor of the data allocating system 100 executes said instructions, the correlation analyzing module 101, the query analyzing module 102, the performance analyzing module 103, the decision module 104, and the transfer module 105 of the data allocating system 100 are driven to perform the functions mentioned in foregoing embodiments. The functions of each module can be referenced to foregoing embodiments and will not be repeated here again.

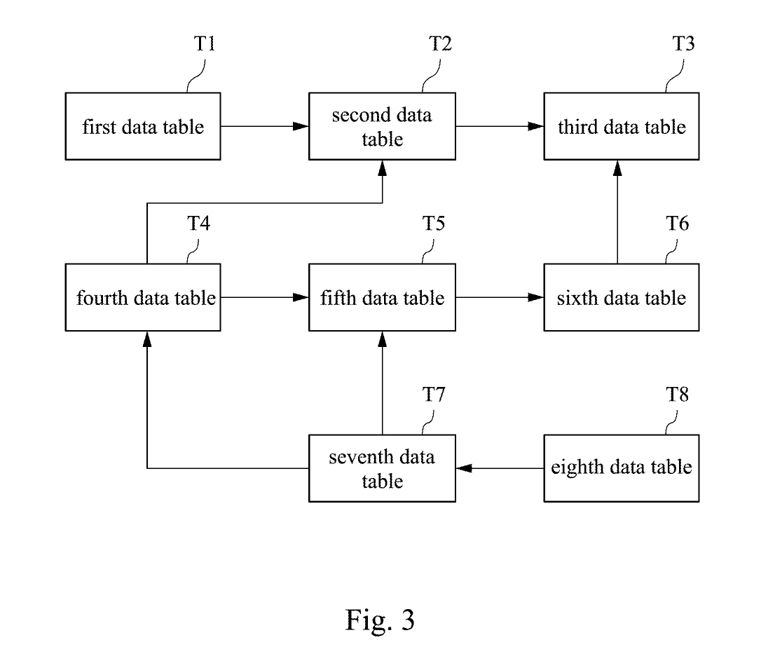

FIG. 3 is a schematic diagram of references among several data tables illustrated according to some embodiments of the present disclosure. In the embodiment, the system configuration of the data allocating system 100, the relational database 200, and the distributed data cluster 300 can be referenced to FIG. 1. In one embodiment, there are eight data tables being stored in the relational database 200 and the references among these data tables are shown in FIG. 3. The formats of these data tables are listed as follows: the first data table T1 is named as PART, which is sized as 24 MB and includes 200 thousand columns of records; the second data table T2 is named as PARTSUPP, which is sized as 114 MB and includes 800 thousand columns of records; the third data table T3 is named as LINEITEM, which is sized as 725 MB and includes 6 million columns of records; the fourth data table T4 is named as SUPPLIER, which is sized as 1.4 MB and includes 10 thousand columns of records; the fifth data table T5 is named as CUSTOMER, which is sized as 24 MB and includes 150 thousand columns of records; the sixth data table T6 is named as ORDERS, which is sized as 164 MB and includes 150 thousand columns of records; the seventh data table T7 is named as NATION, which is sized as 2.2 KB and includes 25 columns of records; the eighth data table T8 is named as REGION, which is sized as 389 Byte and includes 5 columns of records.

In the embodiment, the data allocating system 100 includes the correlation analyzing module 101, the query analyzing module 102, the performance analyzing module 103, the decision module 104, and the transfer module 105. The data allocating system 100 is communicatively coupled to the relational database 200 and the distributed data cluster 300. In the embodiment, the data allocating system 100 is configured to transfer aforementioned data tables from the relational database 200 to the first database 300a, the second database 300b, or the third database 300c of the distributed data cluster 300. It is noted, if the transfer process for transferring these data tables from the relational database 200 to the distributed data cluster 300 is done by a prior art, the result of the transfer process can be listed below: the first data table T1 and the seventh data table T7 are transferred to the first database 300a; the fourth data table T4 and the fifth data table T5 are transferred to the second database 300b; the second data table T2 and the eighth data table T8 are transferred to the third database 300c; and, the third data table T3 and the sixth data table T6 are remained in the relational database 200.

In the embodiment, the correlation analyzing module 101 is configured to analyze the data tables stored in the relational database 200 for the types of the data tables and the sizes of the data tables. In this case, the sizes of the data tables are shown in the paragraph above. The correlation analyzing module 101 is configured to analyze the data tables stored in the relational database 200 based on a dependency structure matrix so as to generate the correlation result with respect to the data tables. The query analyzing module 102 is configured to analyze log records of the relational database 200, extract multiple queries being frequently executed to access the data tables, and generate the query result based on the frequently used queries. In the embodiment, the performance analyzing module 103 is configured to select some testing tables from the data tables, copy the testing tables to each data nodes of the distributed data cluster 300, and generate the performance result according to the execution times that the query result being applied to the testing tables in each database. However, in the embodiment, the query result includes some complicate queries such as Sum query, Avg query, or Order By query, etc.

In the embodiment, the performance result that the performance analyzing module 103 tests the first database 300a, the second database 300b, and the third database 300c is shown below: the CPU time that the execution of the query result being applied to the first database 300a is 54 s 260 ms, and its total time is 102 s; the CPU time that the execution of the query result being applied to the second database 300b is 70 s 840 ms, and its total time is 119 s; and, the CPU time that the execution of the query result being applied to the third database 300c is 68 s 580 ms, and its total time is 115 s. in the embodiment, the decision module 104 is configured to select some data tables to be transferred from the relational database 200 to the first database 300a, the second database 300b and the third database 300c of the distributed data cluster 300 based on the correlation result, the query result and the performance result. The decision module 104 is configured to select one data table with high access rate and another data table in correlation with that data table as the data tables to be transferred to the distributed data cluster 300. Then, the data tables being selected are handled to the transfer module 105 for the transfer process.

In the embodiment, when data allocating system 100 accomplished the transfer process for allocating the data tables form the relational database 200 to the distributed data cluster 300, the result of the transfer process can be listed below: the fourth data table T4 and the seventh data table T7 are transferred to the first database 300a; the fifth data table T5 is transferred to the second database 300b; the first data table T1, the second data table T2 and the eighth data table T8 are transferred to the third database 300c; and, the third data table T3 and the sixth data table T6 are remained in the relational database 200. In a practical experiment has been done, the data table allocation result of present disclosure is much efficient than the data table allocation result done by prior art. In particular, the CPU time and the total time that the queries being applied to the databases are reduced by 20 percent. It is to say, the allocation result of present disclosure evidently improves the efficiency for accessing data tables in distributed databases.

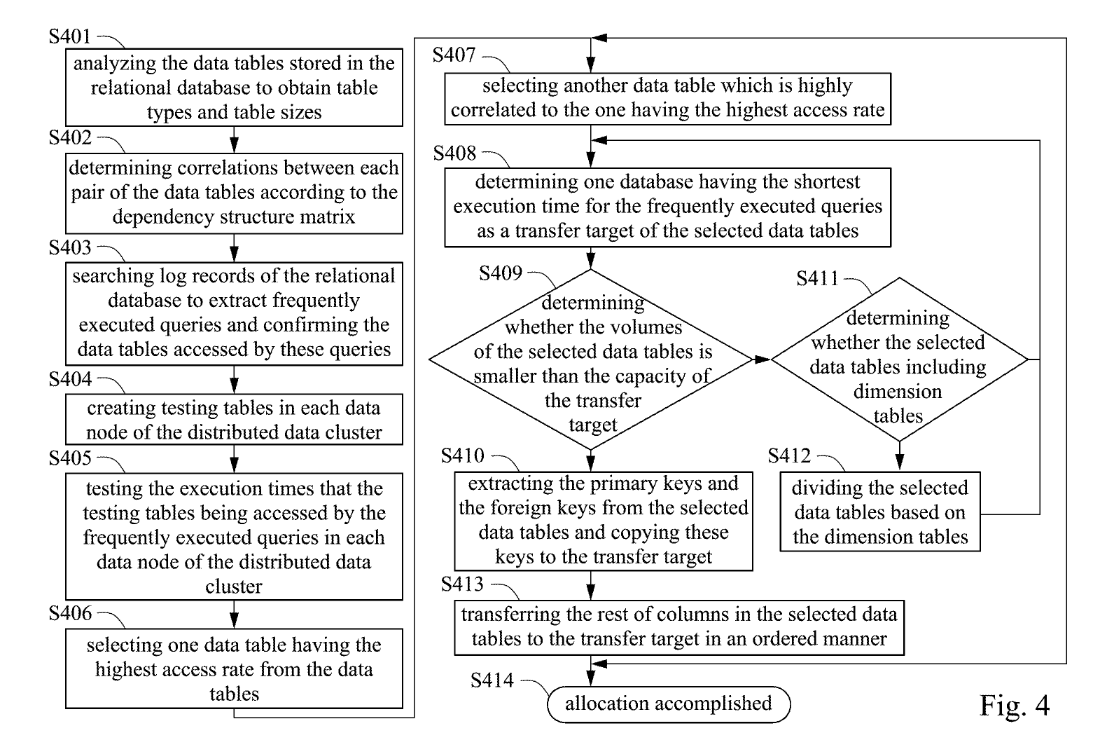

FIG. 4 is a flow chart of a data allocating method illustrated according to some embodiments of present disclosure. In the embodiment, the data allocating method can be executed by the data allocating system 100 shown in FIG. 1. Therefore, the configurations of the data allocating system 100, the relational database 200 and the distributed data cluster 300 can be referenced to foregoing embodiments, especially the embodiment of FIG. 1. In the embodiment the steps of the data allocating method 400 will be listed and explained in detail in following paragraphs.

Step S401: analyzing the data tables stored in the relational database to obtain table types and table sizes. As shown in FIG. 1, in one embodiment, the correlation analyzing module 101 of the data allocating system 100 is configured to analyze the data tables stored in the relational database 200 to obtain the types of the data tables and the sizes of the data tables. In particular, the data allocating system 100 can determine each of the data tables is a fact table or a dimension table via the analysis. Moreover, the data allocating system 100 can obtain the volumes of each data table being stored in the memory.

Step S402: determining correlations between each pair of the data tables according to the dependency structure matrix. As shown in FIG. 1, in the embodiment, the correlation analyzing module 101 of the data allocating system 100 is configured to analyze the data tables stored in the relational database 200 based on a dependency structure matrix. Through the analysis based on the dependency structure matrix, the correlation analyzing module 101 can determine cross-correlations of the access counts of these data tables. After the correlation analyzing module 101 determines the cross-correlations of the access counts between each pair of the data tables in the relational database 200, the correlation analyzing module 101 can calculate the cross-correlations of the data tables based on the normal distribution and generate the correlation result.

Step S403: searching log records of the relational database to extract frequently executed queries and confirming the data tables accessed by these queries. As shown in FIG. 1, in the embodiment, the query analyzing module 102 of the data allocating system 100 is configured to analyze log records of the relational database 200. In the process of searching, the query analyzing module 102 can extract multiple queries that are frequently executed in the relational database 200 to access the data tables. Moreover, the query analyzing module 102 can confirm the data tables that are frequently accessed by these queries in the relational database 200. In the embodiment, the query analyzing module 102 can select the queries associated with high execution frequencies and the data tables being confirmed as frequently accessed to generate the query result.

Step S404: creating testing tables in each data node of the distributed data cluster. As shown in FIG. 1, in the embodiment, the performance analyzing module 103 of the data allocating system 100 is configured to generate a performance result according to several execution times. The execution times are the times that each data node of the distributed data cluster 300 processes the query result, respectively. In the embodiment, the performance analyzing module 103 can select some testing tables from the data tables stored in the relational database 200 according to a predetermined percentage or a predetermined number. When the selection of the testing tables is accomplished, the performance analyzing module 103 can copy testing tables to the first database 300a, the second database 300b and the third database 300c of the distributed data cluster 300, respectively.

Step S405: testing the execution times that the testing tables being accessed by the frequently executed queries in each data node of the distributed data cluster. As shown in FIG. 1, in the embodiment, the performance analyzing module 103 of the data allocating system 100 is configured to evaluate the first database 300a, the second database 300b and the third database 300c by applying the frequently executed queries to the testing tables in these databases, respectively. The evaluation is aiming to test the speeds that the testing tables of each database being accessed by the queries. Based on the evaluation, the performance analyzing module 103 can generate the performance result with respect to each databases of the distributed data cluster 300.

Step S406: selecting one data table having the highest access rate from the data tables. As shown in FIG. 1, in the embodiment, the decision module 104 of the data allocating system 10 is configured to select the data tables to be transferred from the relational database 200 to the distributed data cluster 300 according to the correlation result, the query result, and the performance result. Firstly, based on the query result, the decision module 104 can select one data table having the highest access rate from the data tables as the first target table.

Step S407: selecting another data table which is highly correlated to the one having the highest access rate. As shown in FIG. 1, in the embodiment, after the decision module 104 selected the data table having the highest access rate, the decision module 104 can select another data table which is highly correlated to the first target table as a second target table according to the correlation result and the query result. It is noted, the first target table and the second target table can form the first table set, in which the first table set will be transferred to the distributed data cluster 300.

Step S408: determining one database having the shortest execution time for the frequently executed queries as a transfer target of the selected data tables. As shown in FIG. 1, in the embodiment, the decision module 104 can determine one database from the distributed data cluster 300 as a transfer target of the first table set. The database being selected as the transfer target is the database has the shortest execution time for executing the query result through the first and the second target tables. In the embodiment, the decision module 104 selects the first database 300a as the transfer target of the first table set.

Step S409: determining whether the volumes of the selected data tables is smaller than the capacity of the transfer target. As shown in FIG. 1, in the embodiment, when the decision module 104 selects the transfer target for the first table set, the first table set is handled to the transfer module 105 of the data allocating system 100. The transfer module 105 will conduct the transfer process to transfer the first table set into the first database 300a of the distributed data cluster 300. In the embodiment, during the transfer process, the transfer module 10 can determine whether the volume of the first table set is smaller than the capacity of the first database 300a.

Step S410: extracting the primary keys and the foreign keys from the selected data tables and copying these keys to the transfer target. As shown in FIG. 1, in the embodiment, if the volume of the first table set is smaller than the capacity of the first database 300a, the transfer module 105 can transfer the primary keys and the foreign keys of the first table set to the first database 300a.

Step S411: determining whether the selected data tables including dimension tables. As shown in FIG. 1, in the embodiment, if the volume of the first table set is larger than the capacity of the first database 300a, the transfer module 105 can determine whether the two data tables in the first table set include dimension tables.

Step S412: dividing the selected data tables based on the dimension tables. As shown in FIG. 1, in the embodiment, if the transfer module 105 determines that the two data tables in the first table set include some dimension tables, the transfer module 105 will divide the first table set by reserving the dimension tables and removing some fact tables from the first table set. As such, the volume of the first table set can be reduced. After the division, the decision module 104 can continue to transfer the divided first table set to the first database 300a. For example, in one embodiment, the transfer module 105 can determine how to divide the first table set according to the capacity of the first database 300a. The transfer module 105 is configured to keep most of data in the divided first table set if it is possible, especially to keep the dimension tables. However, it should be noted, if the volume of the divided first table set is still larger than the capacity of the first database 300a when all the data tables in the divided first table set are dimensional tables, the transfer module 105 can divide some dimensional tables into two parts. The part with larger volume can be transferred to the first database 300a in current transfer process, and another part which is smaller can be transferred to other databases in following transfer processes.

Step S413: transferring the rest of columns in the selected data tables to the transfer target in an ordered manner. As shown in FIG. 1, in the embodiment, after the transfer module 105 transfers the primary keys and the foreign keys of the first table set to the first database 300a, the transfer module 105 can re-order the rest of columns in the first table set according to execution frequencies of the queries being recorded in the query result. Then, the transfer module 105 can transfer the re-ordered columns of the first table set to the first database 300a of the distributed data cluster 300.

Step S414: allocation accomplished. As shown in FIG. 1, in the embodiment, when the transfer module 105 accomplishes the transfer process for transferring the first table set to the first database 300a, the decision module 104 can initialize another transfer process. The transfer module 105 can select one of the data tables with the second highest access rate as a third target table and select another data table highly correlated to the third target table as a fourth target table. The third target table and the fourth target table being selected can form the second table set. Based on the performance result, the decision module 104 can select one database from the distributed data cluster 300 as the transfer target of the second table set. And the second table set will be handled to the transfer module for the transfer process. The data allocating system 100 will continue to execute the transfer processes until the transfer module 105 transfers the data tables from the relational database 200 to the distributed data cluster 300. However, it should be noted, based on the requirement, it is not all the data tables should be transferred to the distributed data cluster 300. It is because that present disclosure is aiming to reallocate the data tables to reach a balance, and the balance can improve the efficiency for accessing these data tables in these databases. Therefore, if the configuration that some data tables were left in the relational database 200 provides better efficiency, the data allocating system 100 of present disclosure will execute the transfer processes based on that configuration.

As described in foregoing embodiments, since prior arts are of less concern about the correlations and usages among these data tables in the process of reallocation, when the data tables stored in different databases are accessed, the access time will be delayed by the latencies of some databases. In this regard, the embodiments of present disclosure provide a data allocating system and a data allocating method. The data allocating system executes the transfer process based on the correlations among the data tables, the usage of queries, and the performance of the databases. It has been proved that present disclosure is an approach that evidently increases the efficiency for accessing these data tables.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A data allocating system, applied on a relational data node and a plurality of distributed data nodes, the data allocating system comprising:
a memory, stores a set of instructions; and
a processor, electrically coupled to the memory, configured to access the set of instructions and execute the set of instructions, the processor comprises:
a correlation analyzing module, configured to generate a correlation result according to a correlation of access counts of a plurality of tables being stored in the relational data node;
a query analyzing module, configured to search log reports of the relational data node and generate a query result according to a plurality of queries in the log reports;
a performance analyzing module, configured to test the distributed data nodes with executions of the query result respectively, and generate a performance result according to execution times of the query result being executed by each of the distributed data nodes; and
a decision module, configured to select at least two correlated tables from the tables as a first table set according to the correlation result and the query result, and determines the first table set to be transferred to a first distributed data node of the distributed data nodes according to the performance result.

2. The data allocating system of claim 1, wherein the processor further comprises:
a transfer module, configured to determine whether a volume of the first table set is smaller than a capacity of the first distributed data node;
wherein if the volume of the first table set is smaller than the capacity of the first distributed data node, the transfer module transfers the first table set to the first distributed data node, and
if the volume of the first table set is not smaller than the capacity of the first distributed data node, the transfer module divides the first table set by reserving at least one dimensional table in the first table set, and transfers the divided first table set to the first distributed data node.

3. The data allocating system of claim 2, wherein the transfer module transfers primary keys and foreign keys of the first table set to the first distributed data node, re-orders columns in the first table set according to execution frequencies of the queries being recorded in the query result, and transfers the re-ordered columns to the first distributed data node.

4. The data allocating system of claim 1, wherein the performance analyzing module selects a testing table from the tables, and copies the testing table to each of the distributed data nodes, and generates the query result according to the execution times that each of the distributed data nodes runs the query result through the testing table.

5. The data allocating system of claim 4, wherein the testing table is selected from the tables according to a predetermined percentage or a predetermined number.

6. The data allocating system of claim 1, wherein the decision module determines an access rate of each of the tables according to execution frequencies of the queries being recorded in the query result, and selects one of the tables associated with highest access rate and another table correlated to that table as the first table set.

7. The data allocating system of claim 1, wherein when the first table set is transferred to the first distributed data node, the decision module further selects one of the tables with second highest access rate and another table correlated to that table as a second table set, and the decision module determines the second table set to be transferred to the distributed data nodes.

8. The data allocating system of claim 1, wherein the correlation analyzing module determines the correlation of the access counts of the tables according to a dependency structure matrix (DSM) which records the access counts of the tables, and generates the correlation result according to the correlation of the access counts of the tables.

9. The data allocating system of claim 1, wherein the query analyzing module searches the log reports of the relational data node, obtains the queries being executed on the tables, and selects the queries associated with high execution frequencies as the query result.

10. The data allocating system of claim 1, wherein the decision module selects one of the distributed data node that executes the query result with a shortest execution time from the distributed data nodes as the first distributed data node.

11. A data allocating method, applied on a relational data node and a plurality of distributed data nodes, the data allocating method is executed by a processor, and the processor comprises a correlation analyzing module, a query analyzing module, a performance analyzing module, and a decision module, the data allocating method comprises:
the correlation analyzing module generates a correlation result according to a correlation of access counts of a plurality of tables being stored in the relational data node;
the query analyzing module searches log reports of the relational data node and generates a query result according to a plurality of queries in the log reports;
the performance analyzing module tests the distributed data nodes with executions of the query result, respectively, and generates a performance result according to execution times of the query result being executed by each of the distributed data nodes; and
the decision module selects at least two correlated tables from the tables as a first table set according to the correlation result and the query result, and determines the first table set to be transferred to a first distributed data node of the distributed data nodes according to the performance result.

12. The data allocating method of claim 11, wherein the processor further comprises a transfer module, and the data allocating method further comprises:
the transfer module determines whether a volume of the first table set is smaller than a capacity of the first distributed data node;
wherein if the volume of the first table set is smaller than the capacity of the first distributed data node, the transfer module transfers the first table set to the first distributed data node, and
if the volume of the first table set is not smaller than the capacity of the first distributed data node, the transfer module divides the first table set by reserving at least one dimensional table in the first table set, and transfers the divided first table set to the first distributed data node.

13. The data allocating method of claim 12, further comprising:
the transfer module transfers primary keys and foreign keys of the first table set to the first distributed data node;
the transfer module re-orders columns in the first table set according to execution frequencies of the queries being recorded in the query result; and
the transfer module transfers the re-ordered columns to the first distributed data node.

14. The data allocating method of claim 11, further comprising:
the performance analyzing module selects a testing table from the tables and copies the testing table to each of the distributed data nodes; and
the performance analyzing module generates the query result according to the execution times that each of the distributed data nodes runs the query result through the testing table.

15. The data allocating method of claim 14, wherein the testing table is selected from the tables according to a predetermined percentage or a predetermined number.

16. The data allocating method of claim 11, further comprising:
the decision module determines an access rate of each of the tables according to execution frequencies of the queries being recorded in the query result; and
the decision module selects one of the tables associated with highest access rate and another table correlated to that table as the first table set.

17. The data allocating method of claim 11, further comprising:
when the first table set is transferred to the first distributed data node, the decision module further selects one of the tables associate with second highest access rate and another table correlated to that table as a second table set; and
the decision module determines the second table set to be transferred to the distributed data nodes.

18. The data allocating method of claim 11, further comprising:
the correlation analyzing module determines the correlation of the access counts of the tables according to a dependency structure matrix (DSM) which records the access counts of the tables; and
the correlation analyzing module generates the correlation result according to the correlation of the access counts of the tables.

19. The data allocating method of claim 11, further comprising:
the query analyzing module searches the log reports of the relational data node;
the query analyzing module obtains the queries being executed on the tables; and
the query analyzing module selects the queries associated with high execution frequencies as the query result.

20. The data allocating method of claim 11, further comprising:
the decision module selects one of the distributed data node that executes the query result with a shortest execution time from the distributed data nodes as the first distributed data node.
